(19) United States
(12) Patent Application Publication
(10) Pub. No.: US 2019/0391856 A1
(43) Pub. Date: Dec. 26, 2019

(54) SYNCHRONIZATION OF MULTIPLE QUEUES

(71) Applicant: Intel Corporation, Santa Clara, CA (US)

(72) Inventor: Anil Vasudevan, Portland, OR (US)

(73) Assignee: Intel Corporation, Santa Clara, CA (US)

(21) Appl. No.: 16/018,712

(22) Filed: Jun. 26, 2018

(51) Int. Cl. G06F 9/52

(52) U.S. Cl. CPC G06F 9/522

(57) ABSTRACT

Particular embodiments described herein provide for an electronic device that can be configured to process a plurality of descriptors from a queue, determine that a descriptor is a barrier descriptor, stop the processing of plurality of descriptors from the queue, extract a global address from the barrier descriptor, communicate a message to the global address that causes a counter associated with the global address to be incremented, determine contents of a counter at the global address, perform an action when the contents of the counter at the global address satisfies a threshold, and continue to process descriptors from the queue.

### TECHNICAL FIELD

This disclosure relates in general to the field of computing and/or networking, and more particularly, to the synchronization of multiple queues.

### BACKGROUND

Emerging network trends in data centers and cloud systems place increasing performance demands on a system. The increasing demands can cause an increase of the use of resources in the system. The resources have a finite capability and each of the resources need to be managed.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a block diagram of a system to enable the synchronization of multiple queues, in accordance with an embodiment of the present disclosure;

FIG. 2 is a block diagram of a portion of a system to enable the synchronization of multiple queues, in accordance with an embodiment of the present disclosure;

FIG. 3A is a block diagram of a portion of a system illustrating example details of the synchronization of multiple queues, in accordance with an embodiment of the present disclosure;

FIG. 3B is a block diagram of a portion of a system illustrating example details of the synchronization of multiple queues, in accordance with an embodiment of the present disclosure;

FIG. 4 is a block diagram of of a barrier descriptor illustrating example details of the synchronization of multiple queues, in accordance with an embodiment of the present disclosure;

FIG. 5 is a flowchart illustrating potential operations that may be associated with the system in accordance with an embodiment;

FIG. 6 is a flowchart illustrating potential operations that may be associated with the system in accordance with an embodiment;

FIG. 7 is a flowchart illustrating potential operations that may be associated with the system in accordance with an embodiment;

FIG. 8 is a flowchart illustrating potential operations that may be associated with the system in accordance with an embodiment; and

FIG. 9 is a flowchart illustrating potential operations that may be associated with the system in accordance with an embodiment.

The FIGURES of the drawings are not necessarily drawn to scale, as their dimensions can be varied considerably without departing from the scope of the present disclosure.

### DETAILED DESCRIPTION

### Example Embodiments

The following detailed description sets forth examples of apparatuses, methods, and systems relating to a system for enabling, the synchronization of multiple queues in accordance with an embodiment of the present disclosure. Features such as structure(s), function(s), and/or characteristic(s), for example, are described with reference to one embodiment as a matter of convenience; various embodiments may be implemented with any suitable one or more of the described features.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the following detailed description, reference is made to the accompanying drawings that form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

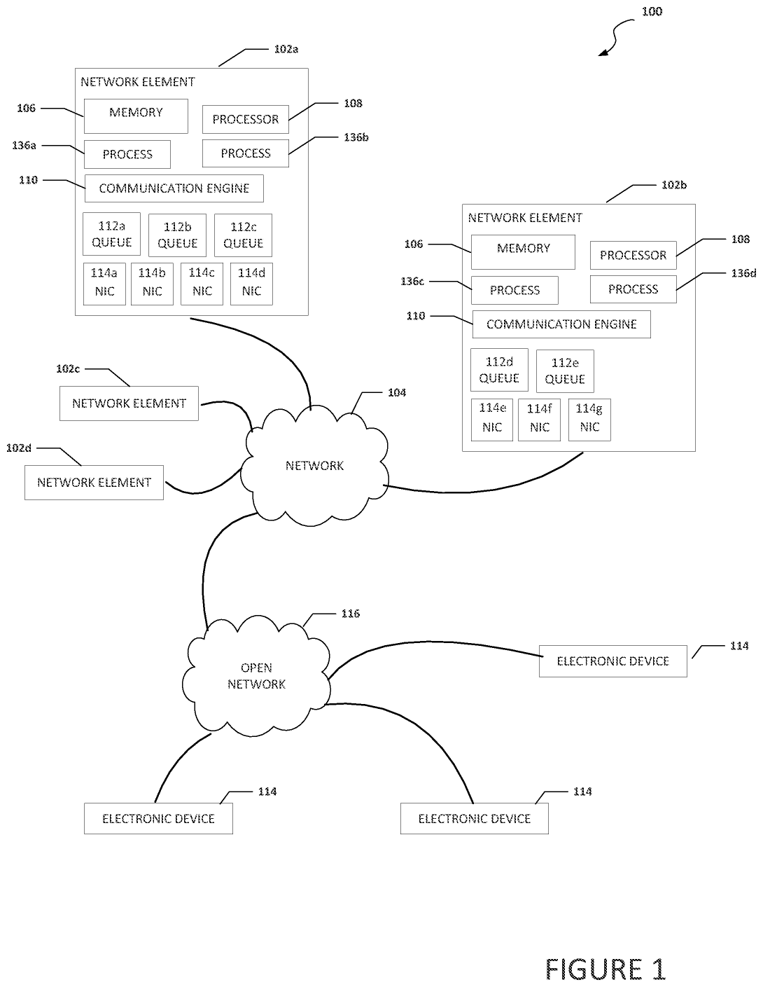

FIG. 1 is a simplified block diagram of an electronic device configured to enable the synchronization of multiple queues, in accordance with an embodiment of the present disclosure. In an example, a system 100 can include one or more network elements 102a-102d. Each network element 102a-102d can be in communication with each other using network 104. In an example, network elements 102a-102d and network 104 are part of a data center.

Each network element 102a-102d can include memory, a processor, a queue synchronization engine, a plurality of queues, one or more NICs, and one or more processes. For example, network element 102a can include memory 106, a processor 108, a queue synchronization engine 110, a plurality of queues 112a-112c, a plurality of NICs 114a-114d, and one or more processes 136a and 136b. Network element 102b can include memory 106, a processor 108, a queue synchronization engine 110, a plurality of queues 112d and 112e, a plurality of NICs 114e-114g, and one or more processes 136c and 136d. Each process 136a-136d may be a process, application, function, virtual network function (VNF), etc.

In some implementations, system 100 can be configured to allow for a NIC assisted synchronization that creates queue drain checkpoints. These checkpoints are used to synchronize queues and enable elastic queuing not only with respect to a NIC, but also with respect to multiple NICs on the same system and/or network element (e.g., NIC 114a and 114b on network element 102a) or across different systems and/or network elements (e.g., NIC 114a on network element 102a and NIC 114e on network element 102b). This allows, system 100 to be configured to allow for granular synchronization between multi-packet processing threads executing on a CPU (e.g., processor 108).

Queues 112a-112e each include a processing thread. Each processing thread includes descriptors. A processor processes the descriptors in each processing thread (one for each queue) until a barrier descriptor is reached. When the barrier descriptor is reached, the processor suspends further processing of descriptors in the processing thread that included the barrier descriptor until a condition is satisfied. For example, when queues (e.g., queues 112a-112c) participate in a synchronization activity (e.g., are resized or rebalanced), a NIC (e.g., NIC 114a) can inject a barrier descriptor into participating queues (e.g., queues 112a-112c). The descriptors in each queue continue to be processed until the processing hits the barrier descriptor. When the barrier descriptor in a processing thread associated with a particular queue is reached, the processing from that particular queue stops and waits until all the participating queues in the synchronization activity also reach their respective barrier descriptor. Once all participating queues are at the barrier descriptor, the queues are synchronized (e.g., at their respective barrier points) and a synchronization activity and/or an action or actions can be taken (e.g., the queues are resized or rebalanced, data is transferred from one queue to another, a queue is taken off line, a queue is brought on line, etc.).

The term “descriptor” includes currently known descriptors and generally includes a memory location and information related to the data at the memory location. In some examples, the descriptor can include instructions to cause one or more events to happen and/or provide status updates (e.g., a specific packet or type of packet was received, a specific packet had a bad checksum, etc.). The term “barrier” includes a stopping point where processing of the descriptors from a queue are suspended. In an example, the processing of the descriptors is suspended until a predetermined event occurs (e.g., a counter at a global address reaches a threshold). The term “barrier descriptor” includes a descriptor that can act as a synchronization point for queues. The barrier descriptor can be added to an existing group of descriptors in a system, environment, and/or architecture and the barrier descriptor is a different type of a descriptor that identifies itself as a barrier, as opposed to a transmit descriptor or a receive descriptor. The terms “synchronization activity,” “synchronization action,” “synchronization of queues,” “queues are synchronized,” and other similar terms include when the queues have reached a common point, for example, when all the descriptor related to an application, portion of an application, operation, function, etc. have been processed.

It is to be understood that other embodiments may be utilized and structural changes may be made without departing from the scope of the present disclosure. Substantial flexibility is provided by system 100 in that any suitable arrangements and configuration may be provided without departing from the teachings of the present disclosure. Elements of FIG. 1 may be coupled to one another through one or more interfaces employing any suitable connections (wired or wireless), which provide viable pathways for network (e.g., network 104, etc.) communications. Additionally, any one or more of these elements of FIG. 1 may be combined or removed from the architecture based on particular configuration needs. System 100 may include a configuration capable of transmission control protocol/Internet protocol (TCP/IP) communications for the transmission or reception of packets in a network. System 100 may also operate in conjunction with a user datagram protocol/IP (UDP/IP) or any other suitable protocol where appropriate and based on particular needs.

For purposes of illustrating certain example techniques of system 100, the following foundational information may be viewed as a basis from which the present disclosure may be properly explained. End users have more media and communications choices than ever before. A number of prominent technological trends are currently afoot (e.g., more computing devices, more online video services, more Internet traffic), and these trends are changing the media delivery landscape. Data centers serve a large fraction of the Internet content today, including web objects (text, graphics, Uniform Resource Locators (URLs) and scripts), downloadable objects (media files, software, documents), applications (e-commerce, portals), live streaming media, on demand streaming media, and social networks. In addition, devices and systems, such as data centers, are expected to increase performance and function. However, the increase in performance and/or function can cause bottlenecks within the resources of the data center and electronic devices in the data center. In a multi thread processing system, an electronic element (e.g., processor) can allocate memory for a specific queue and allocate descriptors. A portion of the allocated memory can be allocated to each descriptor and each descriptor can include an address of the allocated memory associated with each descriptor. When data is received by a network interface controller (NIC), the NIC can use the allocated memory to store data, use/modify the descriptor associated with the allocated memory that includes the data (e.g., to convey some type of information about the data, etc.), and insert the descriptor in the queue.

Currently, some NICs support multiple ingress and egress queues in their host interface to better load balance traffic among multiple cores on a system. However, operations such as dynamically resizing (e.g., on lining or off lining) queues or rebalancing live packet flows among queues relatively quickly without impacting other flows is challenging. Live off lining/on lining of queues is generally not done, in part, due to the unavailability of a deterministic synchronization primitive that is performant. This leads to over utilization of available resources (e.g. at low loads on a server, it is wasteful to have many queues delivering a small number of packets per queue, etc.). The cache footprint, interrupts, and CPU utilization tend to increase with more queues and it is most evident with systems that use busy polling. Also, methods to move live flows from one queue to another are generally not attempted due to the possibility of delivering out of order packets during the transition.

In addition, dynamic resizing of queues is becoming increasingly important for applications that employ intelligent “polling” as a primary means to interact with input/output (I/O). Performance for these applications requires these polling loops to scale with load to better utilize available resources like CPU and memory. Static allocation of queues makes queue provisioning assumptions for the maximum load the queues need to handle. This means that when that the load is low, packets still get distributed among all the available queues, keeping the intelligent “polling” loops active on all of them. This does not use CPU resources efficiently, especially if the load can be handled with fewer queues. One of the main obstacles to dynamically resizing the queues is a lack of a deterministic and quick means for queue synchronization to ensure delivery ordering. What is needed is a system and method to enable the synchronization of multiple queues.

A device to help with the synchronization of multiple queues, as outlined in FIG. 1, can resolve these issues (and others). More specifically, when queues (e.g., queues 112a-112c) are resized or rebalanced, a NIC (e.g., NIC 114a) injects a barrier descriptor at the participating queues (e.g., one or more of queues 112a-112c). The barriers associated with the queues continue to be processed until the processing reaches the barrier descriptor. When the barrier descriptor is reached at a specific queue, the processing from the specific queue stops until all the participating queues also reach their respective barrier descriptor. Once all the participating queues are at the barrier descriptor, the queues are synchronized and an action can be taken that is related to the synchronized queues (e.g., the queues are resized or rebalanced, transfer data from on queue to another, take a queue off line, bring a queue on line, etc.). After the action is taken, descriptor processing continues normally and independently.

In a specific illustrative example, a NIC is associated with four queues, Q1, Q2, Q3, and Q4. Q4 needs to be taken off line and the queues need to be resized/reduced to three and the load from the off lined queue Q4 needs to be split across Q1 and Q3. A queue synchronization engine can use the NIC's control plane to offline Q4 and redirect 04′s traffic to Q1 and Q3. Q4 can be taken off line and a barrier descriptor can be inserted to Q1, Q3, and Q4 to change the queue mapping and allow traffic previously on Q4 to now pass through Q1 and Q3 so all of Q4's traffic goes through Q1 and Q3. The barrier descriptor can be used as an indicator to indicate that the ordering of packets is synchronized once the barrier descriptor is reached, crossed, breached, etc. on Q1, Q3, and Q4.

To synchronize Q1, Q3, and Q4, the queue synchronization engine can process the barrier descriptor and record the number of queues participating in the synchronization. In this example, there are three queues (Q1, Q3, and Q4) and a threshold can be set to three. The barrier descriptor can point to a global address that can be used to determine when the synchronization of the queues is complete. When the global address is accessed, a counter increments the contents of the global address by one (e.g., by using an atomic add operation) until a threshold is reached. In another example, a counter decrements the contents of the global address until a threshold is reached instead of incrementing. In a specific example, the threshold may be zero.

A processing thread is associated with each queue and when the barrier descriptor associated with a specific queue is reached, the processing thread associated with the specific queue causes the global address to be extracted from the barrier descriptor and the contents of the global address are accessed. When the global address is accessed by a processing thread associated with the queue (or causes the contents of the global address to be accessed), the contents of the global address can be reduced until zero is reached and the barrier is breached. In an example, when the global address is accessed, the access includes a request to increment or decrement contents of the global address and the contents of the global address are incremented or decremented.

When the counter satisfies the threshold (e.g., equals the number of participating queues (in this case 3)), the queues are synchronized and each queue can proceed and the descriptors beyond the barrier can be processed as usual. If the counter does not equal the threshold, each queue will wait until the counter satisfies the threshold before proceeding with a next descriptor. For the examples where the number of queues needs to increase instead of decrease, the process is the same and the new queue waits until the participating queues reach their individual barriers as indicated by the counter satisfying the threshold.

In an illustrative example, the barrier descriptor is added to the queues that will accept the data redirected from the queue that will be taken offline, the queue is taken off-line, and a barrier descriptor is inserted into the queue that will be taken offline. When all the barrier descriptors have been reached, the queue that will be taken offline does not include any data and data that was going to the queue that was taken offline can start flowing into the queues that will accept the data redirected from the queue that was taken offline. In a specific illustrative example, if Q4 is going to be taken offline and the data that was going to Q4 will be redirected to Q1 and Q3, a barrier descriptor is inserted into Q1 and Q3. Q4 is taken offline, a barrier descriptor is inserted into Q4, and no further traffic is communicated to Q4. Traffic can still be flowing to Q1 and Q3, but processing of the traffic is stalled until all participating queues reach their respective barrier descriptors. The barrier descriptors ensures that all the data in Q4 is processed before packet processing resumes on the other participating queues (Q1 and Q3) that now handle packets that previously were destined for Q4. Once the barrier descriptors are reached, traffic that was going to Q4 can start flowing into Q1 and Q3 and Q4 does not include any data. This allows all the data in Q4 to be processed before any new data that was originally to be communicated to Q4 is communicated to Q1 or Q3.

In an example involving two NICs, either on the same system or on different systems, NIC-1 has four queues Q1-1, Q1-2, Q1-3, Q1-4, and NIC-2 similarly has four queues Q2-1, Q2-2, Q2-3, Q2-4. If NIC-1 goes off line or needs to be brought down and NIC-2 needed to take over, NIC-1 can use the above example to reduce the queues Q1-1, Q1-2, Q1-3, Q1-4 down to one, for example Q1-1. At that point, NIC-1 can send a sync message targeted to NIC-2. The queue synchronization engine can prepare NIC-1 to go off line and communicate a synchronization message to NIC-2. NIC-2 acknowledges receipt of the synchronization message after it has setup or prepared for traffic originally destined to NIC-1 to be redirected to it from NIC-1. This redirection could either be from the first hop switch (e.g. link aggregation), an SDN controller (e.g. motioning), or a private NIC-1 to NIC-2 protocol. Before NIC-2 turns redirection on, a barrier descriptor can be set up on its local queues or queue. When NIC-1 receives a sync acknowledge signal, a barrier descriptor can also be set up on Q1-1. When Q1-1 hits the barrier descriptor, it means that all data for Q1-1 has been flushed. The system can send a final synchronization complete message to NIC-2, which breaches the barrier at NIC-2. At this point traffic can start flowing on NIC-2.

Turning to the infrastructure of FIG. 1, system 100 in accordance with an example embodiment is shown. Generally, system 100 may be implemented in any type or topology of networks. Network 104 represents a series of points or nodes of interconnected communication paths for receiving and transmitting packets of information that propagate through system 100. Network 104 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Messages through the network could be made in accordance with various network protocols, (e.g., Ethernet, Infiniband, OmniPath, etc.). Additionally, radio signal communications over a cellular network may also be provided in system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, network elements 102a-102d, are meant to encompass network elements, network appliances, servers, routers, switches, gateways, bridges, load balancers, processors, modules, or any other suitable device, component, element, or object operable to exchange information in a network environment. Network elements 102a-102d may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information. Each of network elements 102a-102d may be virtual or include virtual elements.

In regards to the internal structure associated with system 100, each of network elements 102a-102d can include memory elements for storing information to be used in the operations outlined herein. Each of network elements 102a-102d may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media and machine-readable media. In some of these instances, memory elements can store data used for the operations described herein. This includes the memory elements being able to store software, logic, code, or processor instructions that are executed to carry out the activities described herein.

In an example implementation, elements of system 100, such as network elements 102a-102d may include software modules (e.g., queue synchronization engine 110.) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of network elements 102a-102d may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read-only memory (EPROM), an electrically erasable programmable read-only memory (EEPROM)) or an ASIC that includes digital logic, software, code, electronic instructions, or any suitable combination thereof. Any of the potential processing elements, modules, and machines described herein should be construed as being encompassed within the broad term ‘processor.’

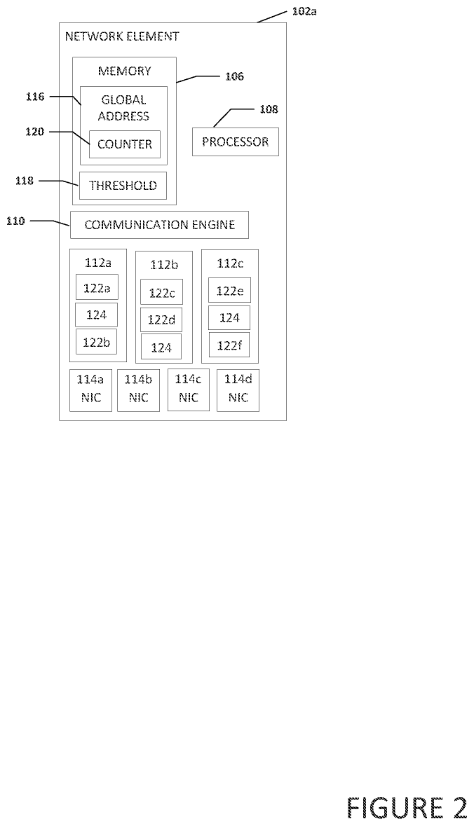

Turning to FIG. 2, FIG. 2 is a simplified block diagram of network element 102a. Network element 102a can include memory 106, a processor 108, queue synchronization engine 110, plurality of queues 112a-112c, and plurality of NICs 114a-114d. Memory 106 can include a global address 116 and a threshold 118. Global address 116 can include a counter 120.

Each of plurality of queues 112a-112c can include one or more descriptors. For example, queue 112a can include descriptors 122a and 122b and barrier descriptor 124. Queue 112b can include descriptors 122c and 122d and barrier descriptor 124. Queue 112c can include descriptors 122e and 122f and barrier descriptor 124. If NIC 114a was using queues 112a-112c but wants to only use queues 112a and 112b (e.g., queue 112c is to be taken off line or otherwise will not be used by NIC 114a) queues 112a-112c must first be synchronized. To enable the synchronization, threshold 118 is set to three because three queues (e.g., queues 112a, 112b, and 112c) must be synchronized. Descriptor 122a in queue 112a is processed until barrier descriptor 124 is reached. Once barrier descriptor 124 in queue 112a is reached, global address 116 is accessed, counter 120 is incremented by one, and the value in counter 120 (which is one) is compared to threshold 118 (which is three).

Descriptor 122b in queue 112a is not processed and the processing of descriptors from queue 112a is temporarily suspended until counter 120 satisfies the value in threshold 118 and all the queue are synchronized. Because counter 120 does not satisfy the value in threshold 118, processing of the descriptors on the other queues continues and descriptor 122c in queue 112b is processed. Because descriptor 122c is not a barrier descriptor, processing of the descriptor in queue 112b continues, descriptor 122d is processed, and then barrier descriptor 124 is reached. Once barrier descriptor 124 is reached, global address 116 is accessed, counter 120 in incremented by one, and the value in counter 120 (which is now two) is compared to threshold 118 (which is three). Because counter 120 does not satisfy the value in threshold 118, processing of the descriptors on the other queues continues. Descriptor 122e in queue 112e is processed, then barrier descriptor 124 is reached. Once barrier descriptor 124 is reached, global address 116 is accessed, counter 120 in incremented by one, and the value in counter 120 (which is three) is compared to threshold 118 (which is three). Because the value in counter 120 matches the value in threshold 118, (e.g., the threshold condition is satisfied), queues 112a-112c are considered synchronized. NIC 114a can start sending data to queues 112a and 112b. NIC 114a can continue to send data to queues 112a and 112b, even with a barrier in place but the barrier descriptor associated with the queues will ensure that data from queues 112a and 112b are not processed until the barrier synchronization is complete.

The contents of the global address are incremented by the processing thread associated with the queue that reached the barrier descriptor. The global address is part of the barrier descriptor which allows the system to scale and use as many queues as necessary or needed for the synchronization process. In an example, the global address includes the counter. In another example, the counter is located in an area of memory other than the area of memory that includes the global address

In an example, queue synchronization engine 110 can be configured to enable a system that allows for synchronization between multi packet processing threads executing on a processor. More specifically, when queues are resized or rebalanced, the NIC injects a barrier descriptor on each of the participating queues. The threads of execution associated with these queues continue to process descriptors until a barrier descriptor is reached. Once the barrier descriptor is reached at a specific queue, the processing thread associated with the specific queue will retrieve the global address from the barrier descriptor and either the specific queue or the system will compare a counter at the global address with a threshold and determine if the counter satisfies the threshold. The counter will satisfy the threshold after each queue has reached their respective barrier descriptor. Once all participating queues are at their respective barrier points, the barrier is breached and descriptor processing continues normally and independently until the next barrier is reached.

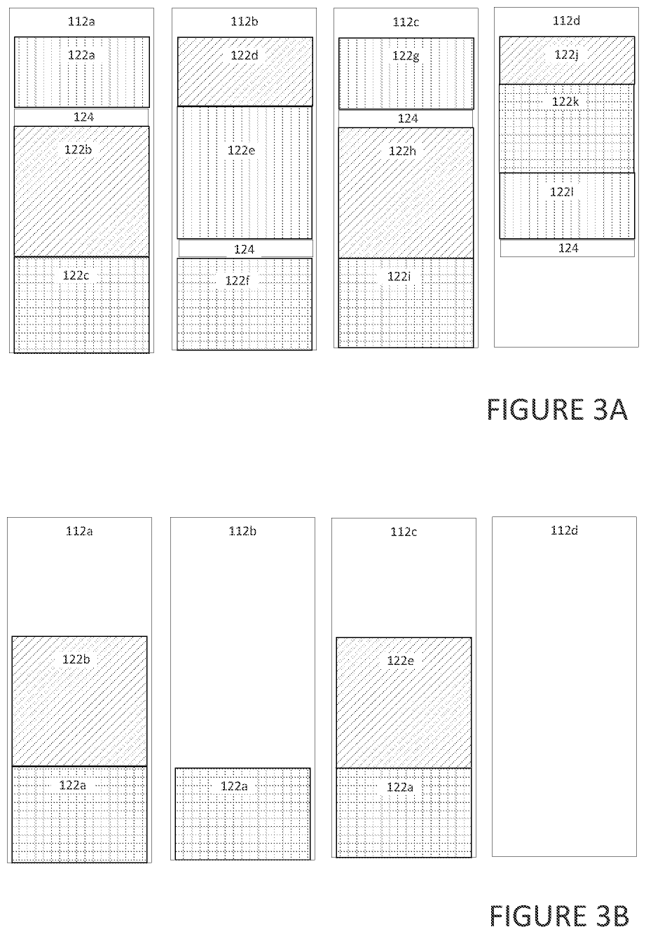

Turning to FIGS. 3A and 3B, FIGS. 3A and 3B are a simplified block diagrams illustrating example details of synchronization of multiple queues, in accordance with an embodiment of the present disclosure. In an illustrative example, queue 112a can include descriptors 122a-122c and barrier descriptor 124, queue 112b can include descriptors 112d-122f and barrier descriptor 124, queue 112c can include descriptors 122g-122i and barrier descriptor 124, and queue 112d can include descriptors 122j-122l and barrier descriptor 124. Descriptors 122a, 122e, 122g, and 122l may relate to the same process (e.g., process 136a illustrated in FIG. 1) and or a NIC (e.g., NIC 114a). In an example, queue 112d needs to be taken offline and the data that was designated to be used by queue 112d needs to be reassigned to queues 112a-122c. However, before that can be done, the queues need to be synchronized. To synchronize the queues, a barrier descriptor can be used. For example, barrier descriptor 124 can be inserted after descriptors 122a, 122e, 122g, and 122l. The descriptors in each of queues 112a-112d can be processed until barrier descriptor 124 is reached.

For example, as illustrated in FIG. 3B, in queue 112a, descriptor 122a was processed and barrier descriptor 124 was reached. In queue 112b, descriptor 122d was processed and because descriptor 122d is not a barrier descriptor, the processing of descriptors in queue 112b continued until barrier descriptor 124 was reached. In queue 112c, descriptor 122g was processed and barrier descriptor 124 was reached. In queue 112d, descriptor 122j was processed and because descriptor 122j is not a barrier descriptor, descriptor 122k was processed, descriptor 122l was processed, and barrier descriptor 124 was reached. Because barrier descriptor 124 was inserted after descriptors 122a, 122e, 122g, and 122l and descriptors 122a, 122e, 122g, and 122l are related to the same process (e.g., process 136a) and/or a NIC (e.g., NIC 114a) and because the processing of descriptors from each of queues 112a-112d was suspended at barrier descriptor 124, the queues are synchronized.

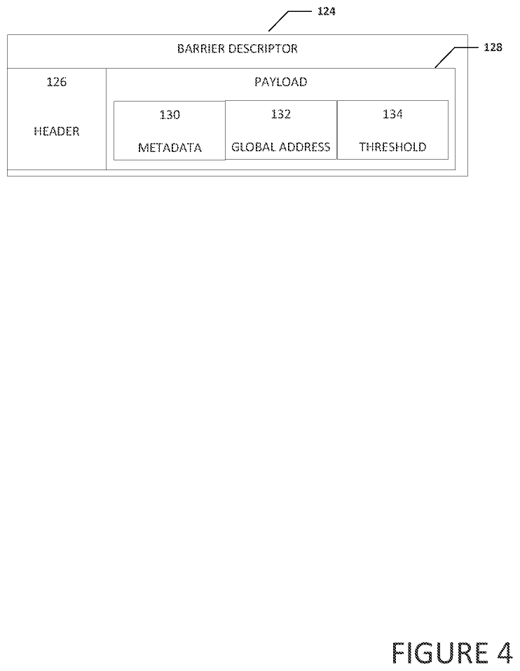

Turning to FIG. 4, FIG. 4 is a simplified block diagram illustrating example details of a barrier descriptor 122, in accordance with an embodiment of the present disclosure. Barrier descriptor 122 can include a header portion 126 and a payload portion 128. Payload portion 128 can include metadata 130, a global address 132, and a threshold 134. Metadata 130 can include metadata that describes and/or provides information related to barrier descriptor 122. In an example, threshold 134 may not be included in barrier descriptor 122, especially if the threshold is zero and the contents of the global address were set up as the threshold (e.g., zero) and are decremented with each access until the contents of the global address reaches zero.

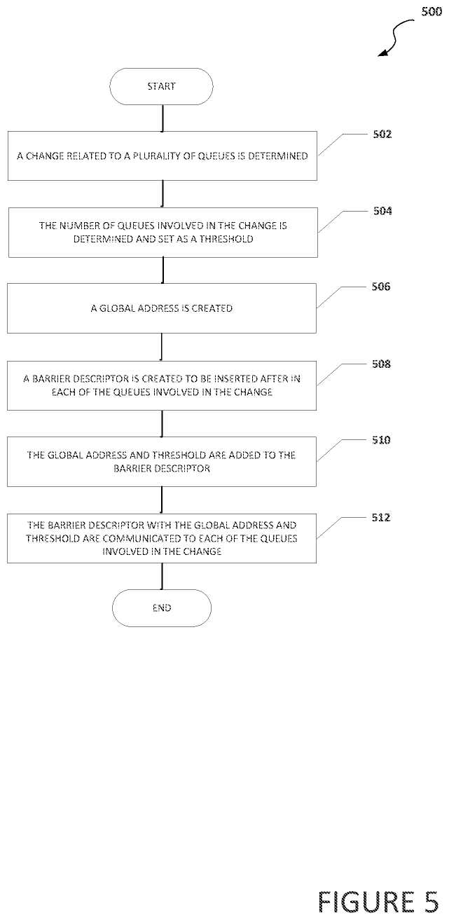

Turning to FIG. 5, FIG. 5 is an example flowchart illustrating possible operations of a flow 500 that may be associated with the synchronization of multiple queues, in accordance with an embodiment. In an embodiment, one or more operations of flow 500 may be performed by queue synchronization engine 110. At 502, a change related to a plurality of queues is determined. At 504, the number of queues involved in the change is determined and set as a threshold. At 506, a global address is created. At 508, a barrier descriptor is created to be inserted in each of the queues involved in the change. At 510, the global address and the threshold are added to the barrier descriptor. At 512, the barrier descriptor with the global address and the threshold are communicated to each of the queues involved in the change.

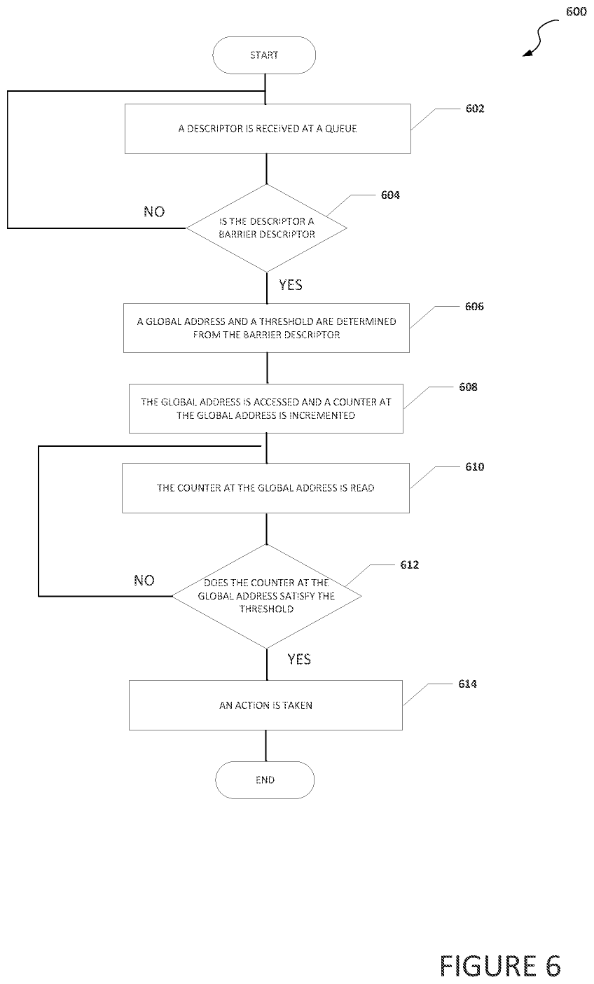

Turning to FIG. 6, FIG. 6 is an example flowchart illustrating possible operations of a flow 600 that may be associated with the synchronization of multiple queues, in accordance with an embodiment. In an embodiment, one or more operations of flow 600 may be performed by queue synchronization engine 110. At 602, a descriptor is received at a queue. At 604, the system determines if the descriptor is a barrier descriptor. If the descriptor is not a barrier descriptor, then the system returns to 602 and waits for another descriptor. In an example, the system can act on the descriptor or otherwise take an action (if any) associated with the descriptor. If the descriptor is a barrier descriptor, then a global address and a threshold are determined (e.g., extracted) from the barrier descriptor, as in 606. At 608, the global address is accessed and a counter at the global address is incremented. At 610, the counter at the global address is read. At 612, the system determines if the counter at the global address satisfies the threshold. If the counter at the global address does not satisfy the threshold, then the system returns to 610 and the counter at the global address is again read (but not incremented). In an example, regular polling of the counter at the global address can occur until the counter at the global address satisfies the threshold. If the counter at the global address does satisfy the threshold, then an action is taken as in 614. In an example, the action may be to close off a queue to a NIC, bring a queue on line, etc.

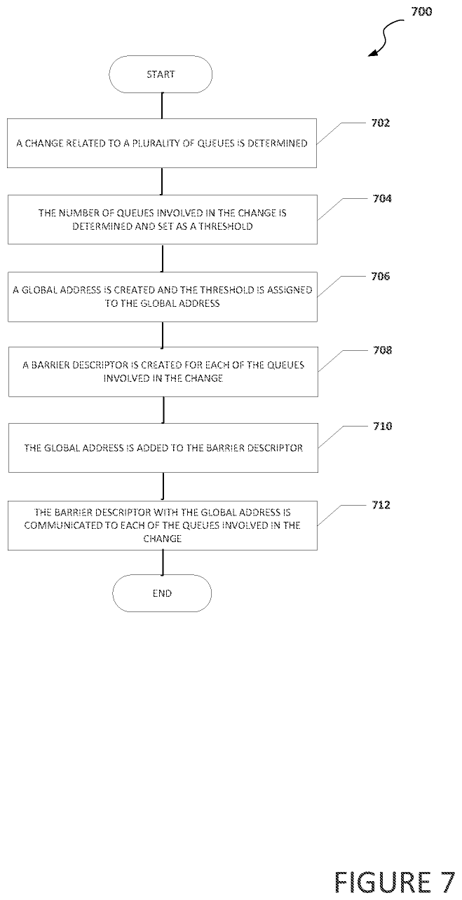

Turning to FIG. 7, FIG. 7 is an example flowchart illustrating possible operations of a flow 700 that may be associated with the synchronization of multiple queues, in accordance with an embodiment. In an embodiment, one or more operations of flow 700 may be performed by queue synchronization engine 110. At 702, a change related to a plurality of queues is determined. At 704, the number of queues involved in the change is determined and set as a threshold. At 706, a global address is created and the threshold is assigned to the global address. At 708, a barrier descriptor is created for each of the queues involved in the change. At 710, the global address is added to the barrier descriptor. At 712, the barrier descriptor with the global address is communicated to each of the queues involved in the change.

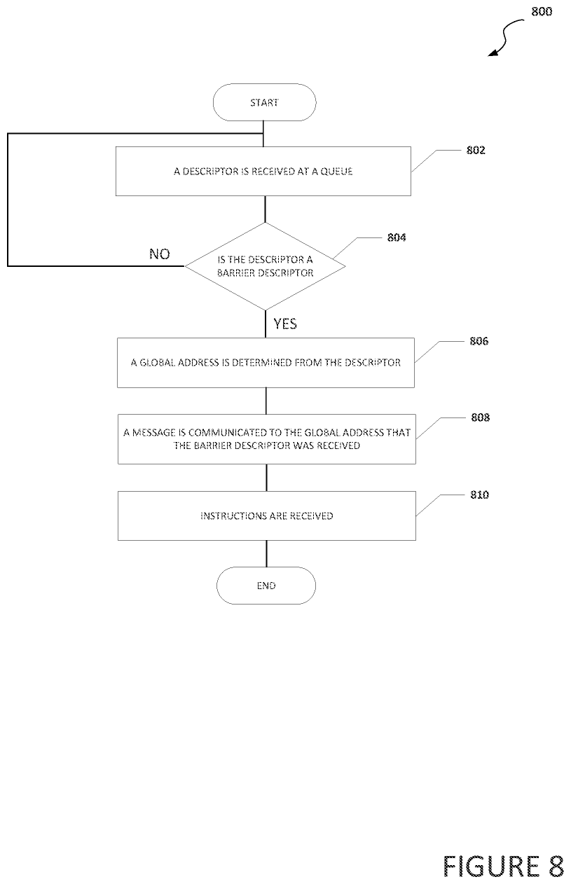

Turning to FIG. 8, FIG. 8 is an example flowchart illustrating possible operations of a flow 800 that may be associated with the synchronization of multiple queues, in accordance with an embodiment. In an embodiment, one or more operations of flow 800 may be performed by queue synchronization engine 110. At 802, a descriptor is received at a queue. At 804, the system determines if the descriptor is a barrier descriptor. If the descriptor is not a barrier descriptor, then the system returns to 802 and waits for another descriptor. In an example, the system can act on the descriptor or otherwise take an action (if any) associated with the descriptor. If the descriptor is a barrier descriptor, then a global address is determined from the barrier descriptor, as in 806. At 808, a message (e.g., an indicator, data, etc.) is communicated to the global address that the barrier descriptor was received. In an example, when the message is communicated to the global address, a counter associated with the global address is incremented. At 810, instructions are received. In an example, the instructions may be from queue synchronization engine 110 after the counter at the global address satisfies a threshold. The instructions may be to take an action, to close off a queue to a NIC, bring a queue on line, etc.

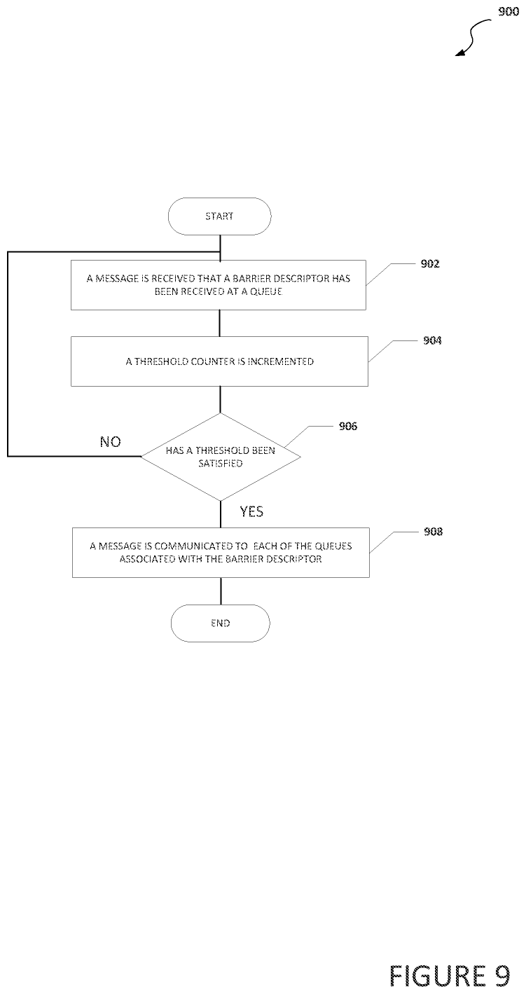

Turning to FIG. 9, FIG. 8 is an example flowchart illustrating possible operations of a flow 900 that may be associated with the synchronization of multiple queues, in accordance with an embodiment. In an embodiment, one or more operations of flow 900 may be performed by queue synchronization engine 110. At 902, a message is received that a barrier descriptor has been received at a queue. For example, the message may have been received at a global address. At 904, a threshold counter is incremented. At 906, the system determines if a threshold has been satisfied. If the threshold has not been satisfied, then the system returns to 902 and waits for a message to be received that a barrier descriptor has been received at a queue. If the threshold has been satisfied, then a message is communicated to each of the queues associated with the barrier descriptor. For example, the message may be from queue synchronization engine 110 after a counter at the global address satisfies a threshold and the message may be to take an action, to close off a queue to a NIC, bring a queue on line, etc.

It is also important to note that the operations in the preceding flow diagrams (i.e., FIGS. 5-9) illustrate only some of the possible correlating scenarios and patterns that may be executed by, or within, system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although system 100 have been illustrated with reference to particular elements and operations that facilitate the communication process, these elements and operations may be replaced by any suitable architecture, protocols, and/or processes that achieve the intended functionality of system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example C1 is at least one machine readable storage medium having one or more instructions that when executed by at least one processor, cause the at least one processor to process a plurality of descriptors from a queue, determine that a descriptor from the plurality of descriptors is a barrier descriptor, extract a global address from the barrier descriptor, communicate a message to the global address that causes a value of a counter associated with the global address to be incremented, determine the value of the counter at the global address, and perform an action when the value of the counter at the global address satisfies a threshold.

In Example C2, the subject matter of Example C1 can optionally include where the one or more instructions further cause the at least one processor to query the global address for the value of the counter until the value satisfies the threshold.

In Example C3, the subject matter of any one of Examples C1-C2 can optionally include where the one or more instructions further cause the at least one processor to stop the processing of the plurality of descriptors from the queue when it is determined that the descriptor is the barrier descriptor and continue to process descriptors from the queue after the action is performed.

In Example C4, the subject matter of any one of Examples C1-C3 can optionally include where the action is to take the queue off line.

In Example C5, the subject matter of any one of Examples C1-C4 can optionally include where the action is to bring a second queue on line.

In Example C6, the subject matter of any one of Examples C1-C5 can optionally include where the one or more instructions further cause the at least one processor to determine a number of queues involved in the action, and set the threshold to the number of queues involved in the action.

In Example C7, the subject matter of any one of Examples C1-C6 can optionally include where the at least one machine-readable medium is part of a data center.

In Example A1, an electronic device can include memory, a queue synchronization engine, and at least one processor. The queue synchronization engine is configured to cause the at least one processor to determine that a descriptor from a queue is a barrier descriptor, stop a processing of descriptors from the queue, extract a global address from the barrier descriptor, communicate a message to the global address that causes a counter associated with the global address to be incremented, determine contents of the counter at the global address perform a synchronization action when the contents of the counter at the global address satisfy a threshold, and continue to process descriptors from the queue after the synchronization action is performed.

In Example A2, the subject matter of Example A1 can optionally include where the queue synchronization engine is further configured to query the global address for the contents of the counter until the contents of the counter at the global address satisfies the threshold.

In Example A3, the subject matter of any one of Examples A1-A2 can optionally include where the queue synchronization engine is further configured to cause the least one processor to determine a number of queues involved in the synchronization action, and set the threshold to the number of queues involved in the synchronization action.

In Example A4, the subject matter of any one of Examples A1-A3 can optionally include where the synchronization action is to take a second queue off line.

In Example A5, the subject matter of any one of Examples A1-A4 can optionally include where the synchronization action is to bring a second queue on line.

Example M1 is a method including processing a plurality of descriptors from a queue, determining that a descriptor is a barrier descriptor, stopping the processing of the plurality of descriptors from the queue, extracting a global address from the barrier descriptor, communicating a message to the global address that causes a value of a counter associated with the global address to be incremented, and performing an action when the value of the counter at the global address satisfies a threshold.

In Example M2, the subject matter of Example M1 can optionally include querying the global address for the value of the counter until the counter at the global address satisfies the threshold.

In Example M3, the subject matter of any one of the Examples M1-M2 can optionally include continuing to process descriptors from the queue after the action is performed.

In Example M4, the subject matter of any one of the Examples M1-M3 can optionally include where the action is to take a second queue off line.

In Example M5, the subject matter of any one of the Examples M1-M4 can optionally include where the action is to bring a second queue on line.

In Example M6, the subject matter of any one of Examples M1-M5 can optionally include where the threshold is equal to a number of queues involved in the action.

Example S1 is a system for the synchronization of multiple queues. The system can include memory, one or more processors, and a queue synchronization engine. The queue synchronization engine is configured to extract a global address from a barrier descriptor, wherein the barrier descriptor is part of a plurality of descriptors processed by the one or more processors, communicate a message to the global address that causes a value of a counter associated with the global address to be incremented, determine the value of the counter at the global address, and perform a synchronization action when the value of the counter at the global address satisfies a threshold.

In Example S2, the subject matter of Example S1 can optionally include where the queue synchronization engine is further configured to query the global address for the value of the counter until the counter at the global address satisfies the threshold.

In Example S3, the subject matter of any one of the Examples S1-S2 can optionally include where the queue synchronization engine is further configured to stop the processing of the plurality of descriptors from the queue when it is determined that the descriptor is the barrier descriptor, and continue to process descriptors from the queue after the synchronization action is performed.

In Example S4, the subject matter of any one of the Examples S1-S3 can optionally include where the synchronization action is to take a second queue off line.

In Example S5, the subject matter of any one of the Examples S1-S4 can optionally include where the synchronization action is to bring a second queue on line.

In Example S6, the subject matter of any one of the Examples S1-S5 can optionally include where the queue synchronization engine is further configured to determine a number of queues involved in the synchronization action and set the threshold to the number of queues involved in the synchronization action.

In Example S7, the subject matter of any one of the Examples S1-S6 can optionally include where the system is part of a data center.

Example AA1 is an apparatus including means for processing a plurality of descriptors from a queue, means for determining that a descriptor from the plurality of descriptors is a barrier descriptor, means for extracting a global address from the barrier descriptor, means for communicating a message to the global address that causes a value of a counter associated with the global address to be incremented, means for determining the value of the counter at the global address, and means for performing an action when the value of the counter at the global address satisfies a threshold.

In Example AA2, the subject matter of Example AA1 can optionally include means for querying the global address for the value of the counter until the value satisfies the threshold.

In Example AA3, the subject matter of any one of Examples AA1-AA2 can optionally include means for stopping the processing of the plurality of descriptors from the queue when it is determined that the descriptor is the barrier descriptor and continue to process descriptors from the queue after the action is performed.

In Example AA4, the subject matter of any one of Examples AA1-AA3 can optionally include where the action is to take the queue off line.

In Example AA5, the subject matter of any one of Examples AA1-AA4 can optionally include where the action is to bring a second queue on line.

In Example AA6, the subject matter of any one of Examples AA1-AA5 can optionally include means for determining a number of queues involved in the action, and means for setting the threshold to the number of queues involved in the action.

In Example AA7, the subject matter of any one of Examples AA1-AA6 can optionally include where apparatus is part of a data center.

Example X1 is a machine-readable storage medium including machine-readable instructions to implement a method or realize an apparatus as in any one of the Examples A1-A5, AA1-AA7, or M1-M6. Example Y1 is an apparatus comprising means for performing any of the Example methods M1-M6. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one machine-readable medium comprising one or more instructions that, when executed by at least one processor, causes the at least one processor to:
process a plurality of descriptors from a queue;
determine that a descriptor from the plurality of descriptors is a barrier descriptor;
extract a global address from the barrier descriptor;
communicate a message to the global address that causes a value of a counter associated with the global address to be incremented;
determine the value of the counter at the global address; and
perform an action when the value of the counter at the global address satisfies a threshold.

2. The at least one machine-readable medium of claim 1, wherein the one or more instructions further cause the at least one processor to:
query the global address for the value of the counter until the value satisfies the threshold.

3. The at least one machine-readable medium of claim 1, wherein the one or more instructions further cause the at least one processor to:
stop the processing of the plurality of descriptors from the queue when it is determined that the descriptor is the barrier descriptor; and
continue to process descriptors from the queue after the action is performed.

4. The at least one machine-readable medium of claim 1, wherein the action is to take the queue off line.

5. The at least one machine-readable medium of claim 1, wherein the action is to bring a second queue on line.

6. The at least one machine-readable medium of claim 1, wherein the one or more instructions further cause the at least one processor to:
determine a number of queues involved in the action; and
set the threshold to the number of queues involved in the action.

7. The at least one machine-readable medium of claim 1, wherein the at least one machine-readable medium is part of a data center.

8. An electronic device comprising:
memory;
a queue synchronization engine; and
at least one processor, wherein the queue synchronization engine is configured to cause the least one processor to:
determine that a descriptor from a queue is a barrier descriptor;
stop a processing of descriptors from the queue;
extract a global address from the barrier descriptor;
communicate a message to the global address that causes a counter associated with the global address to be incremented;
determine contents of the counter at the global address;
perform a synchronization action when the contents of the counter at the global address satisfy a threshold; and
continue to process descriptors from the queue after the synchronization action is performed.

9. The electronic device of claim 8, wherein the queue synchronization engine is further configured to cause the least one processor to:
query the global address for the contents of the counter until the contents of the counter at the global address satisfies the threshold.

10. The electronic device of claim 8, wherein the queue synchronization engine is further configured to cause the least one processor to:
determine a number of queues involved in the synchronization action; and
set the threshold to the number of queues involved in the synchronization action.

11. The electronic device of claim 8, wherein the synchronization action is to take a second queue off line.

12. The electronic device of claim 8, wherein the synchronization action is to bring a second queue on line.

13. A method comprising:
processing a plurality of descriptors from a queue;
determining that a descriptor is a barrier descriptor;
stopping the processing of the plurality of descriptors from the queue;
extracting a global address from the barrier descriptor;
communicating a message to the global address that causes a value of a counter associated with the global address to be incremented; and
performing an action when the value of the counter at the global address satisfies a threshold.

14. The method of claim 13, further comprising:
querying the global address for the value of the counter until the counter at the global address satisfies the threshold.

15. The method of claim 13, further comprising:
continuing to process descriptors from the queue after the action is performed.

16. The method of claim 13, wherein the action is to take a second queue off line.

17. The method of claim 13, wherein the action is to bring a second queue on line.

18. The method of claim 13, wherein the threshold is equal to a number of queues involved in the action.

19. A system for a synchronization of multiple queues, the system comprising:
memory;
one or more processors; and
a queue synchronization engine, wherein the queue synchronization engine is configured to:
extract a global address from a barrier descriptor, wherein the barrier descriptor is part of a plurality of descriptors processed by the one or more processors;
communicate a message to the global address that causes a value of a counter associated with the global address to be incremented;
determine the value of the counter at the global address; and
perform a synchronization action when the value of the counter at the global address satisfies a threshold.

20. The system of claim 19, wherein the queue synchronization engine is further configured to:
query the global address for the value of the counter until the counter at the global address satisfies the threshold.

21. The system of claim 19, wherein the queue synchronization engine is further configured to:
stop the processing of the plurality of descriptors from the queue when it is determined that the descriptor is the barrier descriptor; and
continue to process descriptors from the queue after the synchronization action is performed.

22. The system of claim 19, wherein the synchronization action is to take a second queue off line.

23. The system of claim 19, wherein the synchronization action is to bring a second queue on line.

24. The system of claim 19, wherein the queue synchronization engine is further configured to:
determine a number of queues involved in the synchronization action; and
set the threshold to the number of queues involved in the synchronization action.

25. The system of claim 19, wherein the system is part of a data center.
